(19) United States
(12) Patent Application Publication
(10) Pub. No.: US 2008/0136791 A1
(43) Pub. Date: Jun. 12, 2008

(54) LIQUID RESISTIVE TOUCH PANEL

(75) Inventor: Bengt Fredrik Nissar, Stockholm (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/620,489

(22) Filed: Jan. 5, 2007

Related U.S. Application Data
(60) Provisional application No. 60/868,979, filed on Dec. 7, 2006.

(51) Int. Cl. G06F 3/045

(52) U.S. Cl. 345/174

(57) ABSTRACT

A portable electronic device may include a resistive touch panel that may include an information presentation device. The resistive touch panel may include a flexible outer electrically conducting layer, an inner electrically conducting layer, and a separating chamber containing a liquid may be provided between the outer and inner electrically conducting layers.

### RELATED APPLICATIONS

This application claims priority under 35 U.S.C. § 119 based on U.S. Provisional Application Ser. No. 60/868,979, filed Dec. 7, 2006, the disclosure of which is incorporated herein by reference.

### BACKGROUND

The present invention generally relates to electronic devices and, more particularly, to a resistive touch panel, as well as an information presentation device and a portable electronic device including the resistive touch panel.

In electronic devices such as portable communication devices, such as cellular phones, resistive touch panels are widely used as an input mechanism for receiving information from a user. Touch panels are often provided in conjunction with a display, such as an LCD (liquid crystal display). In such arrangements, the display may be used to render information associated with the information that is entered via the touch panel.

A resistive touch panel is often multi-layered, and may include an outer electrically conducting layer that is typically flexible, and an inner, electrically conducting layer, which are, in a normal (i.e., non-input) state, separated by an air gap. As a user contacts the touch panel (e.g., with a finger, stylus, etc.), the flexible layer is displaced toward the inner layer and the touch may thereby be (electrically) registered; after which, the flexible layer operatively returns to its original position, i.e., at a distance from the inner layer. The separation of the two electrically conducting layers is maintained, for example, using spacers disposed in the air gap.

Touch panels of the type described above are associated with a number of undesirable limitations. As the panel is often to be used in daylight or artificial light, incident light gets reflected from the different layers. The reflected light may create glare or otherwise impact visual acuity from the perspective of the user of the panel. The reflected light may also render the panel a grayish color, thereby limiting the possibility to provide differentiated designs and/or colors of images presented via the panel.

Another limitation of such touch panels is that the flexible layer, after having been pressed towards the inner layer, may not completely return to its original position. That is, an “indentation” may occur in the structure. The indentation may produce so-called, Newton's rings, or similar optical distortions, which are undesirable from the perspective of the user of the panel.

Techniques exist for removing Newton's rings. For example, a translucent or diffusive layer may be provided on the side of the inner layer facing the flexible layer, i.e., in the gap between the flexible layer and the inner layer. The diffusive layer diffuses light from the inner layer, resulting in the removal of Newton's rings. However, the diffusive layer may also diffuse light emanating from a display provided below the touch panel, thereby reducing the sharpness of an image provided by the display. An image to be presented, for example, in a relatively small portable electronic device may be reduced to an unacceptable degree of sharpness when subjected to the diffusive layer. Limited resolution due to small dimensions of the touch panel in such devices places a premium on images being as sharp as possible. This is not possible to do with the above mentioned diffusive layer.

Proposed attempts to resolve some of the unintended optical affects associated with the diffusive layer include replacing the air in the gap with particular materials. In U.S. patent application Publication No. 2003/0020540, for instance, a composite consisting of electrically conducting particles is placed between the two conducting layers. In this arrangement, the electrically conducting particles start to conduct when the flexible layer is depressed. However, the proposed composite will not, in all likelihood, improve the visibility of an underlying display due to the inclusion of the electrically conducting particles. A similar technique is described in Japanese Patent Application No. JP05-0143219.

### SUMMARY OF THE INVENTION

Implementations of the present invention provide a resistive touch panel with superior optical properties.

According to a first aspect of the present invention, a resistive touch panel includes a first flexible electrically conducting layer, a second electrically conducting layer, and a separating chamber provided between the first and second electrically conducting layers, wherein the chamber includes a transparent liquid.

A second aspect of the present invention is directed to a resistive touch panel including the features of the first aspect, wherein the liquid is electrically isolating.

A third aspect of the present invention is directed to a resistive touch panel including the features of the third aspect, wherein the liquid is a chemically non-reactive liquid at least regarding the materials that make up the walls of the chamber.

A fourth aspect of the present invention is directed to a resistive touch panel including the features of the first aspect, wherein the liquid is insensitive to temperature and pressure.

A fifth aspect of the present invention is directed to a resistive touch panel including the features of the first aspect, wherein the liquid has a refractive index that is matched to the refractive index of the first conducting layer.

A sixth aspect of the present invention is directed to a resistive touch panel including the features of the fifth aspect, wherein the refractive index of the liquid is matched to the refractive index of the second conducting layer.

A seventh aspect of the present invention is directed to a resistive touch panel including the features of the fifth aspect, wherein the refractive index of the liquid is higher than the refractive index of air.

An eighth aspect of the present invention is directed to a resistive touch panel including the features of the seventh aspect, wherein the refractive index of the liquid is chosen within an interval that provides reflection for incident light off the liquid in relation to the first electrically conducting layer that is below a selected percentage, which percentage may be 10 percent, with advantage around four percent and preferably less than one percent.

A ninth aspect of the present invention is directed to a resistive touch panel including the features of the first aspect, wherein the liquid is an oil-based liquid.

Other implementations of the present invention provide an information presenting device having an improved resistive touch panel.

According to a tenth aspect of the present invention, an information presenting device includes a resistive touch panel having a first flexible electrically conducting layer, a second electrically conducting layer, and a separating chamber provided between the first and second electrically conducting layers, and a display provided below said resistive touch panel, wherein said chamber comprises a transparent liquid.

Still other implementations of the present invention provide a portable electronic device having an improved resistive touch panel.

According to an eleventh aspect of the present invention, a portable electronic device including a resistive touch panel having: a first flexible electrically conducting layer, a second electrically conducting layer, and a separating chamber provided between the first and second electrically conducting layers, wherein said chamber comprises a transparent liquid.

A twelfth aspect of the present invention is directed to a portable electronic device including the features of the eleventh aspect, in which it is a portable communication device.

A thirteenth aspect of the present invention is directed to a portable electronic device includes the features of the twelfth aspect, in which it is a cellular phone.

Implementations of the invention may allow the provision of clearer images that exhibit superior contrast in high ambient lighting for an associated display. Other implementations may enable the removal of troublesome optical defects, such as Newton's rings. Still other implementations may obviate the need for spacers and other elements designed to counter optical distortions, such as diffusive anti-Newton's ring layers.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The present invention will now be described in more detail in relation to the enclosed drawings, in which:

FIG. 1 shows an exemplary device in which systems and methods described herein may be implemented;

FIG. 2 schematically shows a side view of a component of the exemplary device of FIG. 1, in which systems and methods described herein may be implemented; and

FIG. 3 is a graph of reflectivity as a function of refractive indexes of a liquid used in the component of FIG. 2.

### DETAILED DESCRIPTION OF EMBODIMENTS

An electronic device according to an implementation of the present invention will now be described in relation to a mobile phone. The electronic device may be a portable communication device of some other type, like a cordless phone, a communication module, a PDA (personal digital assistant), or any other type of portable device, for example, for communicating via radio waves. In other implementation, the device may include a gaming machine, a notepad, or any other type of portable electronic device.

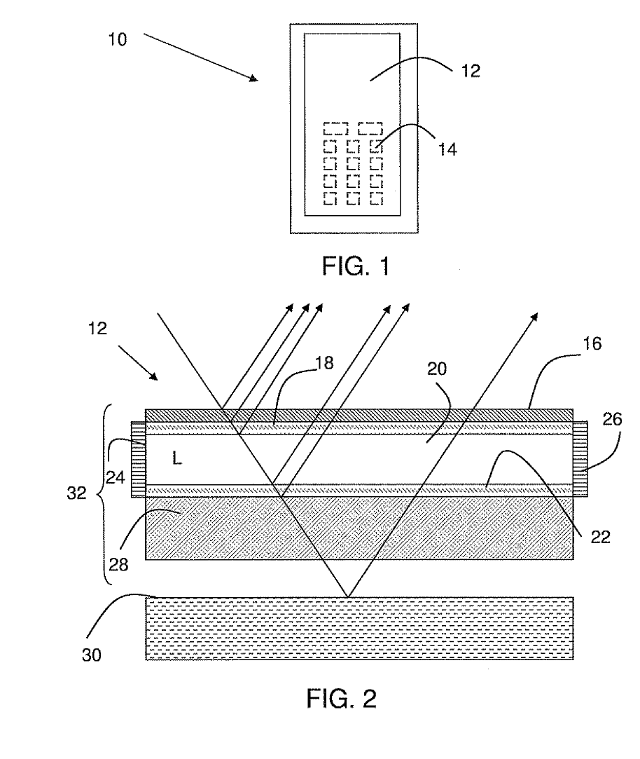

FIG. 1 schematically shows a front view of a phone according to one implementation. Phone 10 may include an information presenting device 12, which may include a touch panel provided over a display. The display may display information in the form of a keypad 14, and when the touch panel is touched in an area where a key is provided, information corresponding to the key may be registered by the touch panel and entered into phone 10.

FIG. 2 schematically shows a side view of the structure of information presenting device 12 according to one implementation. Information presenting device 12 may include a resistive touch panel 32 which may include a substantially transparent shielding layer 16 having an upper side facing the exterior of phone 10. Shielding layer 16 may be used when a user touches it for entering information. Shielding layer 16 may include a hard coat top film and, for instance, made from a plastic material, such as PET. Shielding layer 16 may include a bottom side adjacent an upper side of a flexible first electrically conducting layer 18, which may be provided, for example, in the form of an ITO film, or some other material that is substantially transparent.

The bottom side of first electrically conducting layer 18 may face an upper side of a second electrically conducting layer 22. The two sides may be provided at a predetermined distance from each other. Second electrically conducting layer 22 may include an ITO film. In one embodiment, where touch panel 32 is combined with a display, second layer 22 may be substantially transparent. Alternatively, second layer 22 need not be transparent where no display is to be combined with touch panel 32. To a bottom side of second electrically conducting layer 22, a carrier 28 may be provided, which may be made from glass, plastic, or some other material, including a composite. In some embodiments, carrier 28 may be transparent and, alternatively, may not be, for example, for reasons similar to those given with respect to second electrically conducting layer 22.

Carrier 28 may attach to a display 30. Display 30 may include an LCD (liquid crystal display). Between carrier 28 and display 30, an air gap or a chamber that may contain an adhesive and/or a liquid may be provided. Alternatively, second electrically conducting layer 22 may be provided directly on display 30.

The short sides of first and second electrically conducting layers 18 and 22 that are essentially perpendicular to the top and bottom sides of these layers may connect to each other using two sealing members 24 and 26. Sealing members 24 and 26, together with the bottom side of first electrically conducting layer 18 and the upper side of second electrically conducting layer 22, may form the walls of a chamber 20. Chamber 20 may be filled with a fluid or liquid L. Chamber 20 may be substantially sealed so that liquid L cannot escape from therefrom. In one implementation, chamber 20 may include some fractions of gas, such as air. In one implementation of the invention, no other elements are present in chamber 20, for example, diffusive-type layers and/or spacers.

Liquid L may be characterized by a number of physical, chemical, and/or electrical properties. For example, liquid L may be substantially transparent, for example, so that it readily transmits light. Liquid L may provide electrical isolation, i.e., act as an insulator between first and second electrically conducting layers 18 and 20 in a non-input state. In one implementation, liquid L may be a chemically inert or non-reactive substance, at least regarding the material(s) that comprise the walls of the chamber, i.e., liquid L may not react chemically with first and second electrically conducting layers 18 and 22, as well as sealing members 24 and 26. Liquid L may be thermodynamically invariant relative to temperature and pressure, i.e., liquid L may occupy a substantially constant volume when subjected to varying pressures and temperatures. In one implementation, the thermodynamic properties of liquid L may enable touch panel 32 to be used in any type of climate as well as at any elevation, for instance in aircraft in flight. Liquid L may be, for example, an oil-based liquid, such as an olive oil-based liquid. Other properties are possible. Any one or more of above-mentioned properties may be present in liquid L.

FIG. 2 illustrates a example of how ambient light that is angularly incident upon panel 24 may be reflected from the various interfaces between all the layers of the structure, as well as from the interfaces between liquid L and electrically conducting layers 18 and 22. It should be appreciated that the given exemplary arrows indicating the various paths of light is a simplified representation and is not intended as a compete representation of all of the optic qualities (e.g., intensity, refraction, wavelength, etc.) inherent to any particular arrangement of touch panel 32.

Clarity of images to be presented via display 30, may be based on, at least in part, the number of reflections occurring (for a given photon) in touch panel 32. Of particular interest here, for instance, are the reflections produced by the interfaces between first and second electrically conducting layers 18 and 22 and liquid L in chamber 20.

In one implementation, optical properties of liquid L may include a refractive index that is greater than the refractive index of air. In other implementations, in which liquid L exhibits properties that reflect even less, the refractive index of liquid L may furthermore be matched to the refractive index of at least first electrically conducting layer 18 and, in one implementation, also to the refractive index of second electrically conducting layer 22.

The reflection at an interface may be readily determined according to an equation (1) below, which specifies the reflection for incident light perpendicular to the upper side of first electrically conducting layer 18:

R=(n₁−n₂)²/(n₁+n₂)² Eq. (1)

where R is the reflectivity, n₁ is the refractive index of first electrically conducting layer 18, and n₂ is the refractive index of liquid L.

In one implementation, the refractive index(es) may be chosen so that a suitably low reflectivity may be achieved. The refractive index of liquid L may be chosen, for example, within an interval (i.e., range) that provides reflection for incident light off liquid L in relation to first electrically conducting layer 18 that is at or below a predetermined amount. The reflectivity may be, for instance, less than 100 percent, for example, 50 percent or less, e.g., about forty, thirty, twenty, or ten percent. In some implementations, the predetermined reflectivity may be nine, eight, seven, six, five, four, three, two, or one percent, or any fraction thereof. In yet another implementation, the predetermined amount of reflectivity may be less than one percent. The reflectivity may be readily set based on Eq. (1), by selection of the properties of the refractive index n₁ of first electrically conducting layer 18. For the ITO materials mentioned above, n₁ may be about 1.95. To obtain a reflectivity of below four percent, a corresponding refractive index n₂ of liquid L may be from between about 1.3 and 3.

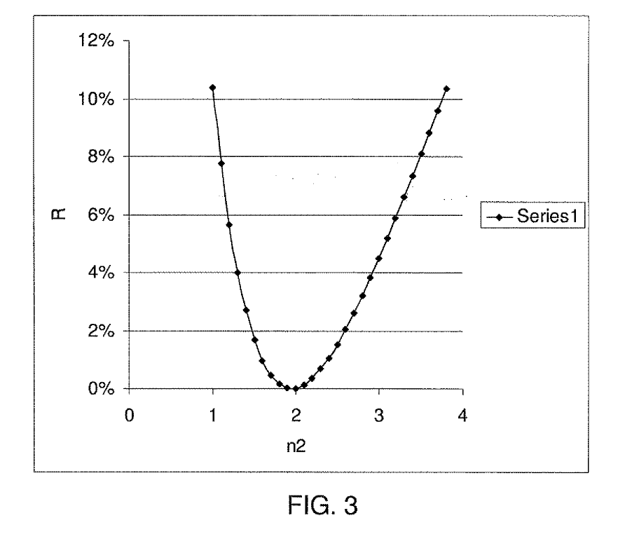

The graph in FIG. 3 shows an exemplary plot of reflectivity as a function of refractive indexes n₂ for liquid L when the electrically conducting material is ITO having a refractive index n₁ of about 1.95. Table 1 below shows the different values for the refractive indexes and the various grades of reflectivity plotted in FIG. 3.

TABLE 1

| n₁ | n₂ | R |
|---|---|---|
| 1.95 | 1 | 10% |
| 1.95 | 1.1 | 8% |
| 1.95 | 1.2 | 6% |
| 1.95 | 1.3 | 4% |
| 1.95 | 1.4 | 3% |
| 1.95 | 1.5 | 2% |
| 1.95 | 1.6 | 1% |
| 1.95 | 1.7 | 0% |
| 1.95 | 1.8 | 0% |
| 1.95 | 1.9 | 0% |
| 1.95 | 2 | 0% |
| 1.95 | 2.1 | 0% |
| 1.95 | 2.2 | 0% |
| 1.95 | 2.3 | 1% |
| 1.95 | 2.4 | 1% |
| 1.95 | 2.5 | 2% |
| 1.95 | 2.6 | 2% |
| 1.95 | 2.7 | 3% |
| 1.95 | 2.8 | 3% |
| 1.95 | 2.9 | 4% |
| 1.95 | 3 | 4% |
| 1.95 | 3.1 | 5% |
| 1.95 | 3.2 | 6% |
| 1.95 | 3.3 | 7% |
| 1.95 | 3.4 | 7% |
| 1.95 | 3.5 | 8% |
| 1.95 | 3.6 | 9% |
| 1.95 | 3.7 | 10% |
| 1.95 | 3.8 | 10% |

According to the above-mentioned Eq. (1), the refractive index n₂ of liquid L may thus be selected within an interval for obtaining a desired reflectivity R for a material property n₁ according to the expression (2) below:

n₁*(1−√R)/(1+√R)<n₂<n₁*(1+√R)/(1−√R) Eq. (2)

Eq. (2) is based on incident light that is perpendicular to the upper side of first electrically conducting layer 18. It should be appreciated that Eq. (2) may be modified based on a modification of Eq. (1), which also considers other angles of incidence.

When the touch panel 32 is used, a user may press on an area of shielding layer 16, which in turn may press down first electrically conducting layer 18 into contact with second electrically conducting layer 22, while displacing liquid L substantially from between first and second electrically conducting layers 18 and 22. The point of contact may then be registered electrically and operatively used in phone 10.

Implementations of the present invention provide a number of advantages. If the liquid is better index matched to the conducting layer than air, the result will be a resistive touch panel, such as touch panel 32, exhibiting comparatively fewer reflections. Thus, the display will appear clearer and exhibit sufficient contrast, for example, when the phone is used in bright sunshine. Another beneficial characteristic of various implementations according to the invention, is that distorting optical effects, such as Newton's Rings, are eliminated. Implementations of the invention also obviate the need for spacers and other elements designed to counter optical problems like diffusive anti-Newton's ring layers. As such, fine tuning of the optical characteristics of the chamber may be achieved. Because of the superior optical properties, the panel will not be rendered a grayish color when not being irradiated by light from a display, thus enabling the possibility to provide differentiated designs and colors via the panel. It will also enable the provision of a sharp image from a display provided under it.

The invention may be provided as only a resistive touch panel, as a combination of a resistive touch panel and display, as well as a resistive touch panel provided in a portable electronic device together with or without a display.

1-13. (canceled)

14. A resistive touch panel comprising:
a first electrically conducting layer, wherein the first electrically conducting layer is flexible;
a second electrically conducting layer; and
a chamber disposed between the first electrically conducting layer and the second electrically conducting layer, wherein the chamber includes a transparent liquid.

15. The resistive touch panel of claim 14, wherein the transparent liquid is electrically insulating.

16. The resistive touch panel of claim 14, wherein the transparent liquid is a chemically non-reactive liquid relative to walls of the chamber.

17. The resistive touch panel of any of claim 14, wherein the transparent liquid exhibits a constant temperature and a constant pressure.

18. The resistive touch panel of claim 14, wherein the transparent liquid has a refractive index that is matched to a refractive index of the first electrically conducting layer.

19. The resistive touch panel of claim 18, wherein the refractive index of the transparent liquid is matched to a refractive index of the second electrically conducting layer.

20. The resistive touch panel of claim 18, wherein the refractive index of the transparent liquid is greater than a refractive index of air.

21. The resistive touch panel of claim 20, wherein the refractive index of the transparent liquid is selected from to provide reflection of a portion of light incident on the transparent liquid that is less than a predetermined value.

22. The resistive touch panel of claim 21, wherein the predetermined value is less than 10 percent.

23. The resistive touch panel of claim 21, wherein the predetermined value is less than 4 percent.

24. The resistive touch panel of claim 21, wherein the predetermined value is less than 1 percent.

25. The resistive touch panel of claim 14, wherein the transparent liquid comprises an oil-based liquid.

26. An information presenting device comprising:
a resistive touch panel including:
a first electrically conductive layer that is flexible,
a second electrically conductive layer, and
a chamber between the first and second electrically conductive layers; and
a display proximate the resistive touch panel, wherein the chamber includes a transparent liquid.

27. An electronic device including a resistive touch panel, the resistive panel comprising:
a first electrically conducting layer, the first electrically conducting layer being flexible;
a second electrically conducting layer; and
a chamber interposed between the first and second electrically conducting layers, wherein said chamber comprises a transparent liquid.

28. The electronic device of claim 27, wherein the electronic device is a portable communication device.

29. The electronic device of claim 28, wherein the electronic device is a cellular phone.
